(19) United States
(12) Patent Application Publication
(10) Pub. No.: US 2010/0011356 A1
(43) Pub. Date: Jan. 14, 2010

(54) INTELLIGENT DISTRIBUTED CONTROLLER

(75) Inventors: Ronald W. Nance, Cypress, TX (US); Don Jay Winningham, Needville, TX (US); Ronald A. Beyer, III, Spring, TX (US); Joseph Chlimoun, Seabrook, TX (US)

Correspondence Address: HUSCH BLACKWELL SANDERS LLP, 190 Carondelet Plaza, Suite 600, ST. LOUIS, MO, 63105, US

(73) Assignee: ELECTROWAVE USA, INC., Channelview, TX (US)

(21) Appl. No.: 12/171,116

(22) Filed: Jul. 10, 2008

(51) Int. Cl. G06F 9/455; G06F 15/16

(52) U.S. Cl. 718/1; 709/202

(57) ABSTRACT

A network of intelligent distributed controls adapted to appear to a programmer as a single virtual device for controlling a system having a pool of all of the inputs and outputs of the various intelligent distributed controllers in the network.

### BACKGROUND OF INVENTION

1. Field of Invention

The present invention relates to control systems and methods as used in various automated plants and manufacturing facilities. More specifically, the present invention relates to a distributed intelligence controller which includes a number of Intelligent Distributed Controllers (IDCs) that behave and are programmable as a single virtual device.

2. Background Art

Control systems are used throughout a variety of industries in situations in which the behavior of systems or devices needs management or control. Plants and factories in which any level of automation is utilized generally contain one or more control systems to regulate the behavior of its machines and processes. Early control systems relied on a centralized processing “brain” which receives input from various sensors and outputs instructions based on those inputs. However, such early control systems incurred a problem standard to centralized systems: a break in communication with the centralized processor effectively brings down the entire system. Additionally, having to install wire runs from each I/O is expensive, time consuming, and is heavy.

Newer distributed control systems utilize controller elements which are not centralized, but are instead spread throughout the system with at least one controller element controlling each sub-system. Often, distributed control systems include a central processor or processors, and remote input/output (I/O) chassis which may have their own processors or just as I/O linked through various communications mediums back to the central processor. When a remote I/O chassis has its own processor, explicit messaging must be performed to obtain data from that processor. Each of these controller elements, often a PLC, is programmed to receive input from various sensors and to transmit instructions based on the input in order to control its subsystem. Such distributed controllers are typically connected via a network for monitoring and communication. Distributed systems somewhat cut down on the need for a centralized “brain,” which allows the system to better function in the event of a break in communication. However, often, one I/O terminal or Data Acquisition Unit (DAU) cannot directly retrieve data from another I/O terminal or DAU even with its own Programmable Logic Controller (PLC) since not more than one PLC may “own” or control a remote I/O terminal or DAU at any one time. Therefore, the remote PLC must request the I/O data through the central PLC adding complexity and overhead to the system. This requires the programmer to write software to specifically gather and act upon data through the central PLC, and still requires extensive wire runs.

In order to program existing distributed control system, it is typically necessary for a programmer to program each PLC separately. Each device must be programmed with instructions for how to control its particular sub-system based on the data it will receive, as well as how to communicate with any other devices and PLCs on the system to or from which it may need to send or receive data. Many such systems may have several thousand or more PLCs, individually programming or reprogramming each of which can be quite difficult and time consuming when needs change.

Further, when programming PLCs individually, each PLC typically receives only the programming relevant to its specific task. Thus, when a PLC breaks down, the entire system may have to be shut down if other PLCs in the system are reliant on input from the malfunctioning PLC. Additionally, when a PLC malfunctions, a replacement PLC must be reprogrammed with its specific job and functionality before it can be properly integrated into the control system, as no PLC stores another PLC's programming information. This leads to further delays in operation of the facility.

Consequently, a need has long been felt for an intelligent distributed control system in which any number of PLCs all store the entire program and which will, to a programmer, all behave and appear as a single virtual device which can exchange run-time or input/output (I/O) data transparently to the programmer without special programming algorithms to exchange the data.

### BRIEF SUMMARY OF THE INVENTION

One or more of the embodiments of the present invention provide for a distributed control system in which a plurality of Intelligent Distributed Controllers (IDCs) are communicably linked by a physical network which may be wired or wireless. An IDC is connected to at least one, but preferably several inputs and outputs which are automatically detected by the IDC at its startup. Each IDC has an electronic memory having electronically stored thereon a kernel command set which preferably includes an operating system, but may be any command set which is capable of achieving transparent communication between IDCs sufficient to achieve the processes explained below, but which a programmer does not see and does not need to be aware of, and which allows each of the IDCs to communicate with at least one other IDC, and preferably with all other IDCs on a network. In an embodiment of the present invention, the kernel command set may include procedures and functions such as READ, WRITE, BROADCAST, SOFTWARE INTERRUPT, I/O INITIALIZE, I/O READ, POWER-ON SELF TEST, FIND MASTER CONTROLLER, PROGRAM VERSION, ARE YOU ALIVE, BOOT LOADING, MASTER ANNOUNCE/ARBITRATION, and USER PROGRAM UPDATE, all of which are explained in detail below. A subset of IDCs on the physical network may form a virtual network in which an IDC in the virtual network communicates only with those IDCs also on the virtual network.

At some point in this embodiment, which is preferably as soon as an input changes but may be at set intervals or on the occurrence of another event, the kernel command set of an IDC automatically instructs a processor function to initiate a broadcast of a portion of its I/O data to at least one other IDC, which is done transparently to the user. This transmission is preferably to all other IDCs but may be to a specific IDC or specific IDCs which are listening for such broadcasts. The IDC's each have respective electronic memories having stored thereon updated I/O values for use by a user application command set. Thus, at any one point, each IDC has stored in its electronic memory a list of all of the I/O values of the system which are up to date. By storing updated I/O values from the other IDCs on the network, each IDC is able to concurrently execute a single user application command set which is written by a programmer to utilize the I/O data of the system to determine appropriate outputs which are necessary to control the system. As each IDC may store all input values and/or all output values from each IDC on the network, each has all of the data necessary to run the entire user application command set.

As an IDC processes the coding of the user application command set, which may be ladder logic or sequential text or other type of coding, it will, at some point, reach a command to change an output. As each IDC has detected its own inputs and outputs, when a change in an output is called for, the IDCs which do not “own” that output ignore the command while the IDC or IDCs which do control that output execute the command. Thus, the user application command set may be written as if for a single device which has a pool of all of the available inputs and outputs of the collective IDCs, and the IDCs in the network behave as a single virtual device. The programmer does not have to program an IDC to send or receive data to or from another IDC, because the kernel command set handles such transmissions transparently, and as all of the IDCs contain the entire user application command set and simply ignore the commands which direct a response to an output which they do not control, a single application is all that is needed to control a system.

One or more embodiments of the present invention provide for an IDC which includes a processor function, a network adaptor which allows for communicably linking the IDC to a physical network which may be wired or wireless and which includes similar IDCs, a first electronic memory and a second electronic memory, and at least one I/O port for communicably linking the IDC to at least a component of a system communicably linked to the network which is detected by the IDC at startup. The first electronic memory has stored thereon a kernel command set which preferably includes an operating system, and the second electronic memory has stored thereon a user application command set. The processor function is operable to execute the commands in both the kernel command set and the user application command set. The execution of the kernel command set allows the IDC to update its I/O data with other IDCs through the network upon the occurrence of some event which is preferably the value changing, but may be at set intervals. The kernel command set similarly contains instructions which tell the IDC to listen for similarly updated I/O data from other IDCs on the network, and the IDC has electronically stored in one of its first and second electronic memories a listing of these I/O values from the other IDCs.

The IDC and the other interrelated IDCs form a network which is communicably linked to a system, where the processor function of each IDC executes the user application command set concurrently with the other IDCs using the updated I/O data from the IDCs from which the IDC has received such data. As the IDC processes the coding of the user application command set, which may be ladder logic or sequential text or other type of coding, it will, at some point, reach a command to change an output. When a change in an output is called for, the IDC knows whether it “owns” the output because it initially detected and is aware of its own inputs and outputs. If it does not “own” that output it ignores the command, whereas if the IDC does control that output it executes the command. This allows the IDC to execute changes in outputs for controlling a portion of the system over which is has control. Thus, the user application command set may be written as if for a single device which has a pool of all of the available inputs and outputs of the collective IDCs, and the IDCs in the network behave as a single virtual device. The programmer does not have to program the IDC to send or receive data to or from another IDC, because the kernel command set instructs the processor function to handle such transmissions transparently, and as all of the IDCs contain the entire user application command set and simply ignore the commands which direct a response to an output which they do not control, a single application is all that is needed to control a system. Thus, the IDCs of the network form a control system for controlling the system.

One or more embodiments of the present invention provide for a method of controlling a system using distributed controllers including enabling each IDC to communicate with at least one other IDC. A plurality of IDCs are networked together such that the IDCs are communicably linked on a network which is communicably linked to a system. A kernel command set, which preferably includes an operating system, is electronically stored in the electronic memory of each IDC of said network and is executed by a processor function allowing intercommunication between the IDCs. This communication includes allowing each IDC to update its I/O data with other IDCs through the network upon the occurrence of some event which is preferably the value changing, but which may be at set intervals. The updated I/O data from the other IDCs on the network allows each IDC to execute a single user application command set, a copy of which each IDC on the network stores in its electronic memory. The user application command set uses the updated I/O data in each IDC to determine the appropriate outputs each IDC must make to control the system. As each IDC stores all input values from each IDC on the network, each has all of the data necessary to run the entire program. When an output is called for, the IDCs which do not control that output ignore the command, while the IDC or IDCs which control that output execute the command. Thus, the user application command set may be written as if for a single device which has a pool of all of the available inputs and outputs of the collective IDCs, and the IDCs in the virtual network behave as a single virtual device. The programmer does not have to program each IDC to send or receive data to or from other IDCs, because the operating system handles such transmissions transparently. As each IDC contains the entire program and simply ignores the commands which direct a response to an output which it does not control, a single program distributed to all of the IDCs is all that is needed to control a system. The kernel command set may also enable an IDC to update at least one of the kernel command set and a user application command set with at least a second IDC, where the second IDC electronically stores the kernel command set and said user application command set in its electronic memory.

Another embodiment of the present invention provides for a method of updating software in distributed controllers comprising the steps of networking a plurality of IDCs together such that said IDCs are communicably linked on a network, and enabling an IDC to update either or both of a kernel command set and a user application command set with at least a second IDC. The at least a second IDC electronically stores the kernel command set and/or the user application command set in an electronic memory of the at least a second IDC. The enabling is accomplished with a kernel command set electronically stored in the electronic memory of the IDC, which may be designated as a Master Controller.

### BRIEF DESCRIPTION OF THE DRAWINGS

For a better understanding of the present invention, reference may be made to the accompanying drawings in which:

FIG. 1 is a block diagram of one example of a prior art control system.

FIG. 2A is a block diagram of an arrangement of IDCs in a network.

FIG. 2B is a block diagram of another arrangement of IDCs in a network.

FIG. 3 is a block diagram of one example of an IDC according to an embodiment of the present invention.

FIG. 4A is a block diagram of simplified IDCs in an embodiment of the present invention.

FIG. 4B is a block diagram of how the physical IDCs of FIG. 4A appear to a programmer in an embodiment of the present invention.

FIG. 5 is a block diagram of the operating system and user application command set structure in an embodiment of the present invention.

FIG. 6 is a flow chart of an IDC “Power On” sequence according to an embodiment of the present invention.

FIG. 7 is a flow chart of an IDC “OS Main Processing Loop” according to the embodiment of FIG. 6.

FIG. 8 is a flow chart of an IDC “Boot-loading” process according to the embodiment of FIG. 6.

FIG. 9 is a flow chart of an IDC “Master Announce/Arbitration” sequence according to the embodiment of FIG. 6.

FIG. 10 is a flow chart of an IDC “User Program Update” sequence according to the embodiment of FIG. 6.

### DETAILED DESCRIPTION OF THE INVENTION

An embodiment of the present invention includes a distributed control system for controlling a system comprising a plurality of intelligent distributed controllers (IDCs) communicably linked by a network. Each IDC has an electronic memory having stored thereon a kernel command set which, when executed, directs each IDC to update at least one of its input/output (I/O) values with at least one other IDC. The electronic memory of each IDC additionally has stored thereon the updated values. Each IDC has a processor function operable to run a single user application command set, stored in the electronic memory of each IDC, concurrently with the other IDCs on the network. When executed, the user application command set is operable to utilize the updated I/O data stored in the electronic memory of each IDC on the network to determine appropriate outputs for controlling a system communicably linked to the network.

An embodiment of the present invention includes an IDC comprising a processor function, a network adapter linked to a network which allows for communicably linking an IDC to the network having other devices communicably linked thereon including other IDCs, and a first electronic memory and a second electronic memory. The IDC additionally has at least one input/output port for communicably linking the IDC to at least a component of a system communicably linked to the network. The first electronic memory has electronically stored thereon a kernel command set which the processor function is operable to execute to direct the IDC to update data from the at least one I/O port with at least one other IDC on the network. The first electronic memory additionally has electronically stored thereon the updated data from the at least one I/O port of the IDC and data from at least one I/O port of at least one other IDC on the network. The second electronic memory has electronically stored thereon a user application command, where the processor function is operable to execute the user application command set which utilizes the updated I/O data to determine appropriate outputs for controlling a portion of the system over which the IDC has control. The processor function is additionally operable to execute the user application command set concurrently with the other IDCs on the network such that all the IDCs on the network form a control system for controlling the system.

Another embodiment of the present invention includes a method of controlling a system using distributed controllers comprising the steps of networking a plurality of IDCs together such that the IDCs are communicably linked on a network, which network is communicably linked to a system, storing a copy of a kernel command set in the electronic memory each IDC on the network, storing a copy of a user application command set in the electronic memory of each IDC on the network, executing the kernel command set in each IDC on the network to enable each IDC to update at least a portion of its input/output (I/O) data with at least one other IDC on the network, where each IDC electronically storing the updated I/O data in its electronic memory, executing the user application command set concurrently in each IDC on the network, the user application command set utilizing the updated I/O data stored in each IDC to determine appropriate outputs for controlling the system such that the IDCs on the network forming a control system which controls the system, and controlling the system with the outputs.

Another embodiment of the present invention includes a method of updating software in distributed controllers comprising the steps of networking a plurality of IDCs together such that the IDCs are communicably linked on a network, and enabling an IDC to update at least one of a kernel command set and a user application command set with at least a second IDC, where the at least a second IDC electronically storing one of the kernel command set and the user application command set in an electronic memory of the at least a second IDC, and where the enabling is accomplished with a kernel command set electronically stored in the electronic memory of the IDC.

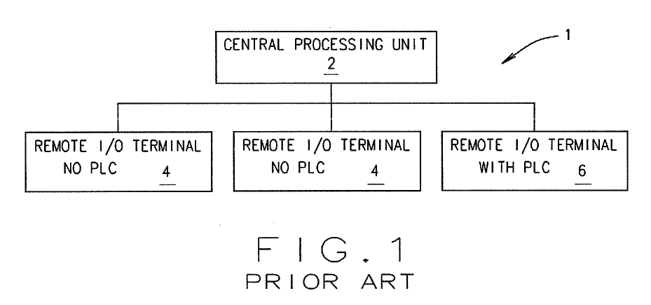

FIG. 1 illustrates a prior art control system 1 including one or more central processor units 2, two remote I/O terminals with no PLC 4, and a remote I/O terminal with a PLC 6. The two remote I/O terminals with no PLC 4 and the remote I/O terminal with a PLC 6 must all be connected back to the central processor unit 2 which increases cost, weight, and complexity of the system. Remote I/O terminal with a PLC 6 must communicate with the central processor unit 2 through explicit messaging to obtain data from the Remote I/O terminal with a PLC 6, which messaging each device must be specially programmed to accomplish.

In such a traditional system, one I/O terminal or Data Acquisition Unit (DAU) cannot directly retrieve data from another I/O terminal or DAU even with its own PLC since not more than one PLC may “own” or control a remote I/O terminal or DAU at any one time. Therefore, a remote PLC must request the I/O data through the central PLC, which requires that the programmer write software to specifically gather and act upon data through the central PLC. Additionally, as such requests for information must go through a central PLC, a great deal of wiring must be in place to connect each controller to the central PLC.

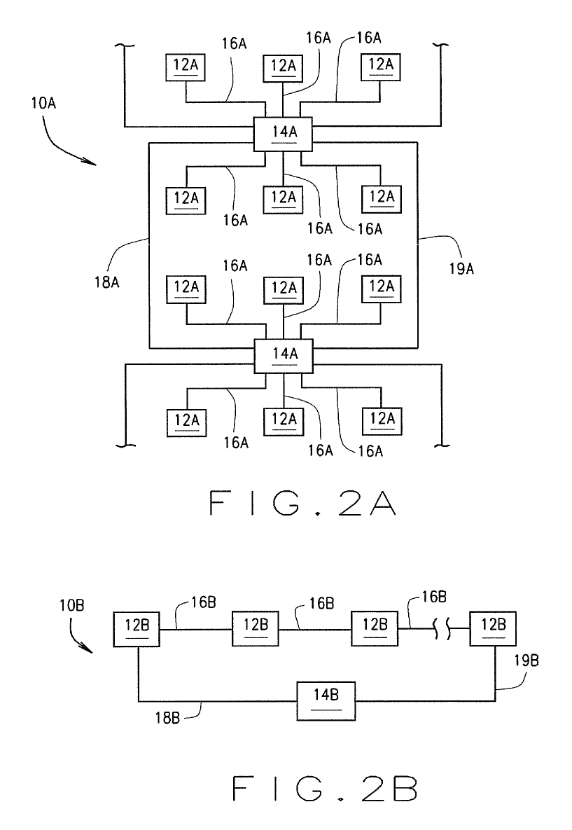

Unlike such prior art control systems, FIGS. 2A and 2B illustrate exemplary arrangements of distributed IDC topology 10A, 10B. As shown in FIG. 2A, the topology of an IDC network 10A may be a typical “Star Configuration” in which a number of IDCs 12A are connected to a network hub 14A via cables 16A which may be copper or fiber optic Ethernet, or may be wireless connections or any other type of networking medium. In such a configuration, each network hub 14A is connected to other network hubs 14A via at least a primary inter-hub connection 18A which may be copper, fiber optic, or any other networking medium. In this way, IDCs 12A are not connected directly to one another, instead being connected through network hubs 14A, which are, in turn, connected to one another. This configuration, in which there is no central PLC through which information requests are routed, significantly lessens the length of wiring and does not require that a programmer program specific requests which must go through a central PLC. For redundancy purposes, the network shown in FIG. 2A is illustrated as having a secondary inter-hub connection 19A. The network hubs 14A may provide power over Ethernet to the IDC modules, and may be off the shelf network hubs.

As shown in FIG. 2B, the topology of a physical IDC network 10B may be a typical “Peer-to-Peer Configuration” in which a number of IDCs 12B are connected directly to one another by inter-IDC cables 16B which may be copper, fiber optic, or any standard networking medium including wireless, and to a switch 14B using a primary connection 18B which may be copper, fiber optic, or any standard networking medium including wireless. This configuration, in which there is no central PLC through which information requests are routed, also significantly lessens the length of wiring and does not require that a programmer program specific requests which must go through a central PLC. For redundancy purposes, there may at least a secondary such connection 19B, in which case switch 14B is preferably a type that supports Fast Spanning Tree protocol such that any inter-IDC cables 16B or the primary or secondary connections 18B, 19B may be broken without affecting the operation of the network 10B. By decentralizing the control system, wire runs are significantly reduced, which decreases the complexity and cost of the control system.

Again, it should be noted that FIGS. 2A and 2B are exemplary only, and any network configuration which can accomplish the goals of an embodiment of the invention is envisioned. IDCs may be generalized programmable logic devices, intelligent buttons or other specialized programmable or non-programmable devices designed to interact and share data on the IDC network with the IDC protocol. The physical IDC network may be comprised of any available networking medium such as Ethernet, Serial, PPP, CAN, etc.

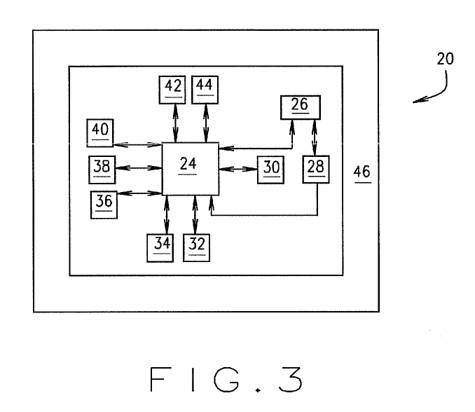

FIG. 3 shows a block diagram of one example of an IDC 20 according to one embodiment of the present invention. It is understood that the configuration and components of the IDC 20 illustrated in FIG. 3 are exemplary and non-limiting, as an IDC with many different configurations and components could be used to accomplish a distributed network of intelligent controllers. As illustrated in FIG. 3, IDC 20 includes a circuit board 22, on which a CPU 24, sub-module bus 26, power supply 28, analogue I/O 30, digital I/O 32, Controller Area Network (CAN) adaptor 34, Ethernet port 36, USB port 38, serial port 40, RAM 42 and ROM 44 are attached. The circuit board 22 and its components are preferably enclosed within an enclosure 46 primarily for protection. The CPU 24 is preferably a micro controller based programmable logic device which is in bidirectional communication with the sub-module bus 26, analogue I/O 30, digital I/O 32, Controller Area Network (CAN) adaptor 34, Ethernet port 36, USB port 38, serial port 40, RAM 42 and ROM 44. The power supply 28 supplies power to the CPU 24 and the sub-module bus 26.

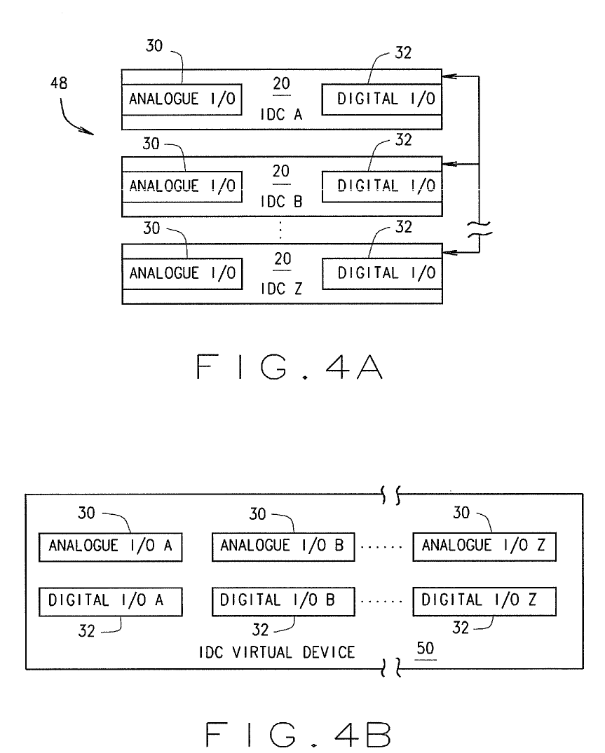

The sub-module bus 26 may be a set of data and power lines that allow external modules to be connected, either directly or through a cable, to a module that's purpose is to extend the functionality of the base unit by providing additional I/O or proprietary communications interfaces. Ethernet port 36 is preferably adapted to receive copper or fiber optic cable capable of 10/100/1000 speeds in full or half duplex. Each port may be single or multiple ports, and the digital and analogue I/Os 30, 32 may have any number of I/O ports and may be any type of port. USB port 38 is preferably USB 1.0 to 2.0 compliant, and Serial port 40 is preferably complaint with the RS-232 standard. The CAN port is preferably configured such that a number of IDCs 20 can be networked together, as shown in FIG. 4A, to form a physical network 48 to share I/O data and a user application command set, which is stored in the electronic memory 42, 44 of each IDC 20. When the CPU 24 of each IDC 20 executes the commands of the IDC operating system which is also stored in the electronic memory 42, 44 of each IDC 20, the IDCs 20 automatically transmit updated I/O data to the other IDCs 20 in the network such that each IDC 20 stores the updated I/O data of the control system. With I/O data from the other IDCs 20 on the network 48, each IDC 20 is able to execute the entire command set of the user application, merely ignoring those commands which require an output response which is not controlled by that particular IDC 20. Thus, as shown in FIG. 4B, a user is able to program the user application command set as if the IDCs 20 in the control system were a single virtual IDC 50 with all of the I/O data of the entire control system without the need to program each IDC 20 with its individual functionality and how and/or when to transmit data to another IDC 20. Indeed, the programmer needs to have no knowledge of how the IDCs 20 interact to exchange data with the object of completing the task programmed. This significantly lessens the programming burden on the programmer.

Adding a new IDC 20 to the system is also much easier, as the new IDC 20 does not need to be specifically programmed, though preferably a name will be given to a new IDC 20. Each IDC 20 stores an entire copy of the same user application command set, which can be downloaded to the new IDC 20 from another IDC 20. Further, subsets of IDCs 20 on the physical network 48 may be divided out into one or more virtual networks, which allow distinct control systems to operate on the same physical network 48 without interfering with one another. The IDCs 20 on different virtual networks may act as different virtual IDCs 50 with different user application command sets, but may communicate with one another.

FIG. 5 illustrates a block diagram of the operating system structure 52 in the memory 42, 44 of an IDC 20. Preferably, the kernel command set includes an operating system which is comprised of a kernel 53, an Application Interface (API) 54, a device driver subsystem 56. The kernel 53 is preferably a multitasking monolithic kernel, and the API 54 is preferably implemented through software interrupts in a similar fashion to Linux, though various differing configurations are envisioned. The device driver subsystem 56 preferably includes drivers for USB 60, General Programmable I/O (GPIO) 62, Timers 64, Real Time Clock (RTC) 66, Synchronous Peripheral Interface (SPI) 68, Inter-Interface Communications (I2C) 70, Variable voltage or current inputs or outputs (Analogue) 72, Tag Database (Tag DB—memory stored network values that are updated through the physical I/O) 74, CAN 76, Ethernet 78, Memory 80 and Motor Control 82. Other drivers may be added as needed. The user application command set 84 is preferably separated in memory from the IDC OS 52, and interacts with the kernel 53 and device driver subsystem 56 through the API 54. The IDC OS 52 may also perform the basic tasks of updating the Tag DB of other IDCs 20, sending network updates to other IDCs 20, handling the intelligent logic process, etc. The IDC OS 52 of the Master Controller may also store and update values not tied to a physical output.

By way of example, when an IDC 20 is initialized, an I/O initialization function, which may be firmware or may be stored in non-volatile memory or may be a part of the kernel 53, is preferably called which automatically detects each analogue 30 and digital 32 I/O to which the IDC 20 is connected. Each is automatically assigned a name, which may, for example, follow the following formula: “<Device Name>.<D for Digital; A for Analogue><I for Input; O for Output>:<sequential number>”. Thus, the 4th digital input for a device named “Pump” would be “Pump.DI:3” under this exemplary formula. This allows each IDC 20 to know which inputs and outputs it is connected to. The IDC 20 would then preferably call a write function of the kernel 53, which would write each of the I/O names to the Tag Database in the electronic memory 42, 44 of the IDC 20 through the Tag DB driver 74. The IDC 20 would then also call a broadcast function of the kernel 53, which preferably utilizes the CAN driver 76 and possibly at least another driver depending on how the IDCs 20 are networked together to broadcast an update of that IDC's 201/Os 30, 32 and their values to the other IDCs 20 on the network, effectively adding that IDC's I/Os 30, 32 to the pool of I/O 30, 32 in the network. A similar write and broadcast procedure is followed when an IDC 20 updates an I/O value with the other IDCs 20 on the network. Additionally, as each IDC 20 on the network is listening for such broadcasts from other IDCs 20, upon receiving such a broadcast, an IDC 20 would then preferably call its own write function of its kernel 53, which would write each of the new I/O names and/or values to the Tag Database in the electronic memory 42, 44 of the IDC 20 through the Tag DB driver 74. This exemplary sequence of kernel 53 command functions allows each IDC 20 to initialize and update its I/O 30, 32 names and/or values with the other IDCs 20 of the network.

As each IDC 20 carries a complete copy of the user application command set 84 and a Tag Database in its memory 42, 44 of all input values from all IDCs 20, each IDC 20 is capable of executing the entire user application command set 84 and merely ignoring commands for an output which that IDC 20 does not control. The programmer of the user application command set 84 preferably has knowledge of what each input and output is connected to while writing the program, whether this information is detected by the IDCs 20 and passed to the programmer or the programmer has prior knowledge of these connections. In any case, the programmer preferably has access to a list of all IDCs 20 on the network and their inputs and outputs when writing the user application command set 84. The IDCs 20 effectively appear to the programmer as a single virtual device 50 with a pool of inputs and outputs. Thus, only one user application command set 84 needs to be written and distributed to all IDCs 20. However, an IDC 20 may store multiple user application command sets 24 which are executed at the same time or sequentially, depending on the needs of the programmer.

As a hypothetical simplified example of a distributed control system in accordance with at least one embodiment of the present invention, consider a system with three IDC 20 devices named “MCBox,” “Valve” and “Pump.” MCBox has at least one digital input 32, one of which is named MCBox.DI:0. Pump has at least one digital output 32, one of which is named Pump.DO:1. In this example, as each of the three IDC 20 devices store the entire user application command set 84 in memory 42, 44 and run the user application command set 84 concurrently, each comes across a hypothetical command in the user application command set 84 to set Pump.DO:1 to true when MCBox.DI:0 is true.

When the MCBox IDC 20 comes to this command in the user application command set 84, the user application command set 84 calls a read function in the kernel 53 to read the latest digital input zero 32 value from the Tag Database of the MCBox IDC 20 using the Tag DB driver 74. The user application command set 84 may alternatively call a I/O read function in the kernel 53 to read in the latest value of digital input zero 32 using the GPIO driver 62. In any case, the CPU 24 evaluates digital input zero 32 to determine its state. If the state is true, MCBox will attempt to set Pump's digital output one 32 to true, and if the state is false, MCBox will attempt to set Pump's digital output one 32 to false. However, as the operating system 52 in the MCBox IDC 20 knows that this output does not belong to MCBox because of its previously performed I/O initialization function, it ignores the request to change the output state of Pump.DO:1. The user application command set 84 continues to run.

When the Valve IDC 20 comes to this command in the user application command set 84, the user application command set 84 calls a read function in the kernel 53 to read the latest digital input zero 32 value from the Tag Database of the Valve IDC 20 using the Tag DB driver 74. The CPU 24 then evaluates its network stored value for MCBox's digital input zero 32 to determine its state. If the Valve IDC's 20 value for MCBox's digital input zero 32 is in error (cannot communicate with MCBox or the device has faulted), the Valve IDC 20 may run on the last stored value, halt the program, run with a fail-safe value, or take some other action depending on the programmer's configuration. If the state of the stored value is true, Valve will attempt to set Pump's digital output one 32 to true, and if the state of the stored value is false, Valve will attempt to set Pump's digital output one 32 to false. However, as the operating system 52 in the Valve IDC 20 knows that this output does not belong to Valve because of its previously performed I/O initialization function, it ignores the request to change the output state of Pump.DO:1. The user application command set 84 continues to run.

When the Pump IDC 20 comes to this command in the user application command set 84, the user application command set 84 calls a read function in the kernel 53 to read the latest digital input zero 32 value from the Tag Database of the Valve IDC 20 using the Tag DB driver 74. The CPU 24 then evaluates its network stored value for MCBox's digital input zero 32 to determine its state. If the Pump IDC's 20 value for MCBox's digital input zero 32 is in error (cannot communicate with MCBox or the device has faulted), the Pump IDC 20 may run on the last stored value, halt the program, run with a fail-safe value, or take some other action depending on the programmer's configuration. If the state of the stored value is true, Pump will attempt to set its digital output one 32 to true, and if the state of the stored value is false, Pump will attempt to set its digital output one 32 to false. As the operating system 52 in the Pump IDC 20 knows that this output does in fact belong to Pump because of its previously performed I/O initialization function, it performs the request to change the output state of PumpDO1. The user application command set 84 continues to run.

The commands in the user application command set 84 may be as simple or complex as the programmer desires, but generally consists of commands to set outputs according to some variable or variables, which may be I/O 30, 32 data or timing or user input, etc. Such user application command sets 84 may be written in any computer language including ladder logic and sequential text.

In the alternative, a set of user application command sets 84 may be distributed to groups of IDCs 20, where each of these groups would function as separate virtual IDCs 50. Additionally, an IDC OS 52 may be intelligent enough to transmit updated input values only to those IDCs 20 which need the those input values to determine if an output is needed, in which case IDCs 20 which do not receive such values would preferably be able to proceed without such data, possibly by skipping commands which have outputs not assigned to and affected by those specific IDCs 20. IDC 20 names and input/output 30, 32 designations and hardware connections may be programmed into the IDC manually, or each may be designated automatically. When an IDC 20 joins a virtual network, it adds its physical I/O 30, 32 capabilities to the virtual device 50 I/O “pool.” This I/O pool may then be used by the programmer to create a user application command set. Additionally, each IDC 20 may store all of the input and/or output values from all IDCs 20 on its network 48, or may store only a portion of the input and/or output values from the IDCs 20 on its network 48. An IDC 20 may store only those values which it needs to execute commands which direct an output which that IDC 20 controls. Alternatively, an IDC 20 may direct an output change in a component of a system to which the IDC's 20 network 48 of IDCs 20 is connected without being directly connected to the output.

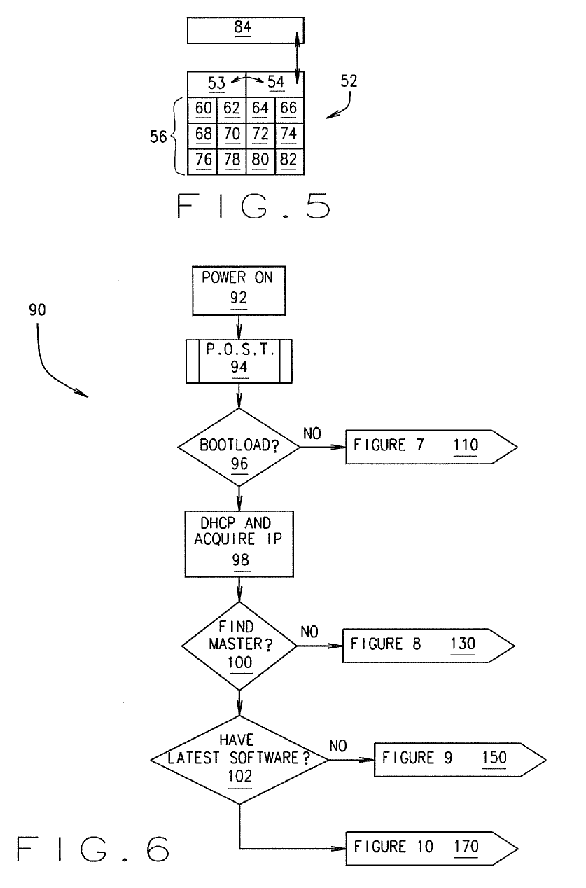

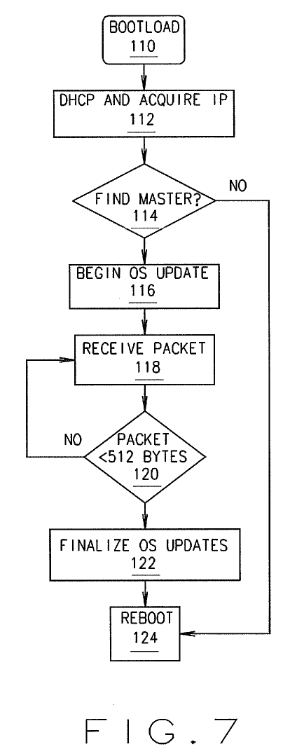

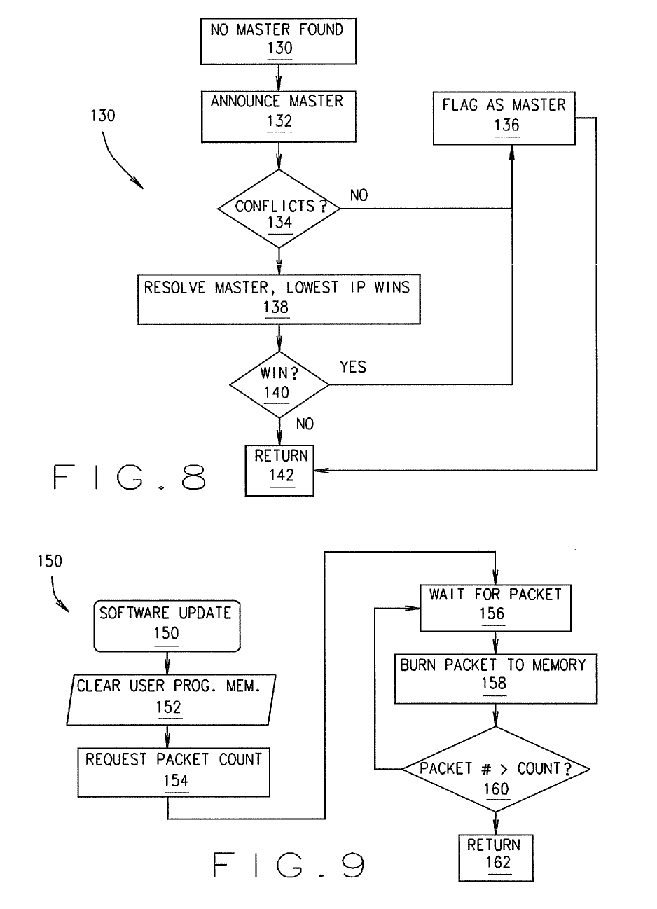

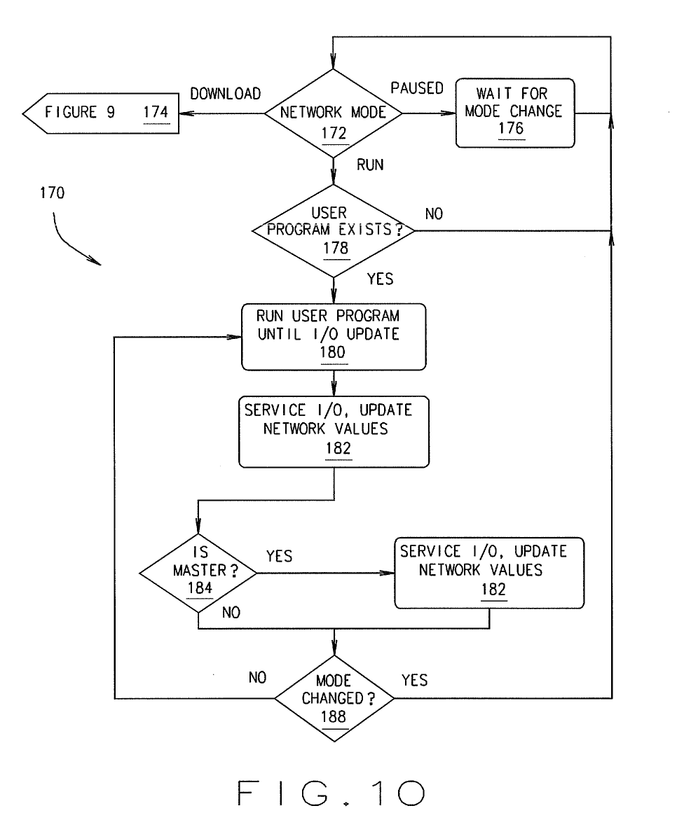

FIGS. 6-10 are flow diagrams which illustrate the exemplary functionality of an IDC 20 in an embodiment of the present invention. FIG. 6 illustrates an exemplary IDC Power-on procedure 90. After an IDC 20 is powered on at step 92, it performs a Power-on Self Test function at step 94. The IDC 20 the checks to see if can boot-load the operating system at step 96. If it cannot, the Boot-loading Procedure 110 shown in FIG. 7, which will be described later, is called. Everything that happens prior to the actual boot-loading of the kernel command set may be controlled through firmware or through commands stored in non-volatile memory such as ROM 44, or by any other suitable manner known in the art. Each of the different functions that occur after boot loading are contained in the kernel command set. If the IDC 20 can boot-load its OS, it does so and proceeds to step 98 where it utilizes Dynamic Host Configuration Protocol (DHCP) and acquires an IP address. IDC 20 then proceeds to step 100 in which it performs a function which determines if a Master Controller exists on its network by broadcasting a request for a response from the Master Controller. If there is no Master Controller found on the network, the Master Announce/Arbitration procedure 130 shown in FIG. 8, which will be described later, is called. If a Master Controller is found, IDC 20 performs a function to check if it has the latest version of the user application command set at step 102 preferably by requesting the user application command set 84 version and comparing the version against that of its own stored copy. If it does not, the User Program Update procedure 150 shown in FIG. 9, which will be described later, is called. If the IDC 20 has the latest software, it proceeds to the OS Main Processing Loop 170 shown in FIG. 10, which will be described later.

FIG. 7 illustrates an exemplary Boot-loading Procedure 110, as mentioned above. When the Boot-loading Procedure 110 is called, the IDC 20 proceeds to step 112 where it utilizes Dynamic Host Configuration Protocol (DHCP) to acquire an IP address. Once the IDC 20 has an IP address, it moves to step 114 and calls another function which attempts to locate the Master Controller on the network by broadcasting a signal over the network seeking the Master Controller. Once the Master Controller responds, the IDC 20 begins to download the kernel command set or kernel command set updates preferably from the Master Controller at step 116 and receives a packet at step 118 which it writes to memory 30, 32 using a write function. If the packet is less than 512 bytes at step 120, IDC 20 reverts back to step 118 to receive another packet. If the packet is not less than 512 bytes at step 120, IDC 20 finalizes the kernel command set updates at step 122 and reboots at step 124. If no Master Controller is found on the network at step 114, the IDC 20 reboots at step 124.

FIG. 8 illustrates an exemplary Master Announce/Arbitration Procedure 130, as mentioned above. If no Master Controller is found at step 100, the Master Announce/Arbitration Procedure 130 is called and the IDC 20 announces itself as Master Controller at step 132 by broadcasting on the network. The IDC 20 then checks for conflicts at step 134 by listening for other Master Announces or communication from a Master Controller. If it finds no conflicts, it calls the broadcast function and flags itself as the Master Controller at step 136 by broadcasting its status over the network. If it finds a conflict, the IDC 20 resolves which IDC becomes the Master Controller of those in conflict by lowest IP address at step 138. If the IDC 20 has the lowest IP address at step 140, it flags itself as the Master Controller at step 136. If the IDC 20 has flagged itself as the Master Controller at step 136, or if it did not have the lowest IP at step 140, the Master Announce/Arbitration Procedure 130 ends and the IDC 20 returns to the call point at step 142. As such, the Master Controller may be “floating” in that any IDC 20 may be master or become master. The Master Controller controls the downloading of firmware updates and software updates without the interaction of a user, and can initiate downloading of updated command sets when necessary, such as to an IDC 20 newly connected to the network.

FIG. 9 illustrates an exemplary User Program Update Procedure 150, as mentioned above. When the IDC 20 determines that it does not have the latest user application command set at step 102, the User Program Update Procedure 150 is called and the IDC 20 clears the user application command data memory at step 152. The IDC 20 then requests the packet count at step 154, preferably from the Master Controller, and begins waiting for packets at step 156. Once a packet is received, its data is burned into memory at step 158. When the IDC 20 determines that there are more packets to receive at step 160, it returns to step 156 and continues waiting for packets. When the IDC 20 determines that it has received all of the packets, it returns to the call point at step 162.

As each IDC 20 is capable of downloading the kernel command set and user application command set 84 from other IDCs 20 on the network at Power-Up, the time and effort needed to program new or replacement IDCs is minimal, and the system downtime is minimal or non-existent. Other IDCs 20 may continue to operate with fail safe or last know values, allowing for continued productivity.

FIG. 10 illustrates an exemplary Main Processing Loop 170, as mentioned above. When the IDC 20 begins to execute the Main Processing Loop 170, it begins in Network Mode at step 172. From here, the IDC 20 may be told to download an updated version of the User Application Command Set at step 174 (which calls the User Application Update Procedure 150), may be paused such that the IDC 20 will wait for a mode change at step 176, or can be set to run. If set to run, IDC 20 checks to see if the user application command set exists at step 178. If it does not, IDC 20 reverts to Network Mode at step 172. If the user application command set does exist, IDC 20 runs the user application command set until there is an I/O required update at step 180. When there is an I/O update, IDC 20 updates the network values stored in other IDCs 20 regarding its inputs and outputs at step 182. When the operating system 52 detects an input change, it calls a software interrupt and services the update by using the write function to write the new value to memory 42, 44, and by using the broadcast function to update other IDCs 20. When the user application command set 84 requires a change to an output, it calls a software interrupt with the name of the output and the state to which it needs to be changed, using whichever driver applies to that type of output. IDC 20 then checks to see if it is the Master Controller at step 184, and if it is, it keeps track of the updating and lost nodes at step 186. Once step 186 is completed, or if the IDC 20 is not the Master Controller from step 184, the IDC checks to see if there has been a mode change at step 188. If there has been a mode change, IDC 20 reverts back to Network Mode at step 172. If there has been no mode change, IDC 20 reverts back to running the User Application Command Set until there is an I/O update at step 180.

The function which keeps track of lost nodes allows the Master Controller to intervalically broadcast “Are You Alive?” messages to the other IDCs 20 on the network. Any IDC 20 which does not respond is marked in the memory of the Master Controller IDC 20 as a failed device. The Master Controller then broadcasts to the other IDCs 20 on the network which IDCs 20 have failed. A user will have programmed the IDCs 20 to use a fail-safe value for any I/O values of the failed IDCs 20, or a last known value, or an error value, etc.

Additionally, an IDC 20 may store and execute a second or more user application command sets 84 in the same manner as it does the first user application command set, still operating as a single virtual device, but as a part of multiple virtual devices. IDC 20 may update the network values stored with all IDCs 20 on its network, or may update only those IDCs 20 which will use that value to execute a command which affects an output controlled by those other IDCs 20.

Thus, an embodiment of the present invention teaches a control system in which a number of IDCs all store the entire program that is written to control a system. To a programmer of such a program, all of the IDCs appear and behave as a single virtual device which can exchange run-time or I/O data transparently to the programmer without special programming algorithms to exchange the data.

One or more embodiments of the present invention provide for a control system in which a kernel command set stored by a number of IDCs on a network store the entire program that is written by a programmer to control a system. The kernel command set exchanges updated I/O data with the other IDCs on the network ensuring that each IDC has all of the updated I/O data of each IDC on the network. This results in all of the IDCs appearing and behaving as a single virtual device with a pool of I/O data from the point of view of a programmer. Thus, only a single program needs to be written to control the system to which the network of IDCs is connected, as each IDC executes the program concurrently and simply ignore commands to change an output which are not controlled by that particular IDC. This increases the ease with which a control system can be programmed, and allows for a Master Controller to automatically update the kernel command set and the program in any IDCs newly connected to the network.

While particular elements, embodiments, and applications of the present invention have been shown and described, it is understood that the invention is not limited thereto because modifications may be made by those skilled in the art, particularly in light of the foregoing teachings. It is therefore contemplated by the appended claims to cover such modifications and incorporate those features which come within the spirit and scope of the invention.

We claim:

1. A distributed control system for controlling a system comprising:
a plurality of intelligent distributed controllers (IDCs) communicably linked by a network,
each said IDC having an electronic memory having stored thereon a kernel command set which, when executed, directs each IDC to update at least one of its input/output (I/O) values with at least one other IDC,
where said electronic memory of each said IDC additionally having stored thereon said updated values,
where each said IDC having a processor function operable to run a single user application command set, stored in each said electronic memory, concurrently with the other IDCs on said network,
where, when executed, said user application command set is operable to utilize said updated I/O data stored in said electronic memory of each said IDC on said network to determine appropriate outputs for controlling a system communicably linked to said network.

2. The distributed control system of claim 1 where said kernel command set includes an Operating System.

3. The distributed control system of claim 1 where a subset of all of the IDCs on said network forms a virtual network in which an IDC in said virtual network is operable to update its I/O values only in those IDCs also in said virtual network.

4. The distributed control system of claim 1 where each said IDC having stored in its electronic memory updates of all input values from all other IDCs on said network.

5. The distributed control system of claim 4 where each said IDC having electronically stored in its electronic memory updates of all output values from all other IDCs on said network.

6. The distributed control system of claim 1 where each IDC having stored in its electronic memory only those updated I/O values which it uses to execute a command which affects an output controlled by said IDC.

7. The distributed control system of claim 1 where the processor function of each IDC is operable to execute all commands of said user application command set, and is additionally operable to ignore any instruction which would affect an output which said IDC does not control.

8. The distributed control system of claim 1 where said processor function of each said IDC being operable to run at least a second user application command set, stored in said electronic memory, concurrently with the other IDCs on said network,
where, when executed, said at least a second user application command set is operable to utilize said updated input and output data stored in said respective electronic memories of said IDCs of said network to determine appropriate outputs for controlling a second system communicably linked to said network.

9. The distributed control system of claim 1 where said electronic memory is a first electronic memory of each said IDC storing said kernel command set, and a second electronic memory of each said IDC storing said user application command set.

10. The distributed control system of claim 1 where any IDC on said network is capable of being a Master Controller such that Master Controller status is floating.

11. The distributed control system of claim 10 where a said processor function of at least the Master Controller IDC executing said kernel command set additionally directing said IDC to transmit a copy of at least one of said kernel command set and said user application command set to another IDC which is newly connected to said network.

12. The distributed control system of claim 10 where a processor function of at least the Master Controller IDC executing said kernel command set additionally directs said IDC to transmit a copy of at least one of said kernel command set and said user application command set to another IDC when at least one of said kernel command set and said user application command set are updated in said electronic memory of said Master Controller IDC.

13. The distributed control system of claim 1, where said network of IDCs appearing to a programmer of said user application command set as a single virtual device.

14. An intelligent distributed controller (IDC) comprising:
a processor function;
a network adapter linked to a network which allows for communicably linking an IDC to said network having other devices communicably linked thereon including other IDCs;
a first electronic memory and a second electronic memory;
said IDC having at least one input/output port for communicably linking said IDC to at least a component of a system communicably linked to said network;
said first electronic memory having electronically stored thereon a kernel command set which said processor function is operable to execute to direct the IDC to update data from said at least one I/O port with at least one other IDC on said network, and where said first electronic memory having electronically stored thereon said updated data from said at least one I/O port of said IDC and data from at least one I/O port of at least one other IDC on said network; and
said second electronic memory having electronically stored thereon a user application command,
where said processor function is operable to execute said user application command set which utilizes said updated I/O data to determine appropriate outputs for controlling a portion of said system over which said IDC has control,
where said processor function is additionally operable to execute said user application command set concurrently with the other IDCs on said network such that all said IDCs on said network form a control system for controlling said system.

15. The intelligent distributed controller of claim 14 where said kernel command set includes an Operating System.

16. The intelligent distributed controller of claim 14 where said IDC and a subset of the IDCs on said network forms a virtual network in which said IDC has stored thereon only those I/O updated values from those IDCs also in said virtual network.

17. The intelligent distributed controller of claim 14 where said IDC has stored thereon updates of all input values from all other IDCs on said network.

18. The intelligent distributed controller of claim 14 where said IDC has stored thereon updates of all output values from all other IDCs on said network.

19. The intelligent distributed controller of claim 14 where said IDC has stored thereon only those updated I/O values from those other IDCs which it uses to execute a command which affects an output controlled by said IDC.

20. The intelligent distributed controller of claim 14 where the processor function of the IDC is operable to execute all commands of said user application command set, and is additionally operable to ignore any instruction which would affect an output which said IDC does not control.

21. The intelligent distributed controller of claim 14 where said processor function is operable to execute at least a second user application command set, stored in said electronic memory, which utilizes said updated input and output values to determine appropriate outputs for controlling a part of a system over which said IDC has control,
where said processor function is operable to execute said at least a second user application command set concurrently with other IDCs on said network such that all said IDCs on said network form a control system which controls said system by using said updated values to concurrently execute copies of said at least a second user application command set.

22. The intelligent distributed controller of claim 14 where said IDC is capable of being a Master Controller such that Master Controller status is floating.

23. The intelligent distributed controller of claim 22 where said processor function of the IDC executing said kernel command set additionally directing said IDC to transmit a copy of at least one of said kernel command set and said user application command set to another IDC which is newly connected to said network when said IDC is a Master Controller.

24. The intelligent distributed controller of claim 22 where a processor function of the IDC executing said kernel command set additionally directs said IDC to transmit a copy of at least one of said kernel command set and said user application command set to another IDC when at least one of said kernel command set and said user application command set are updated in said electronic memory of said IDC when said IDC is a Master Controller.

25. A method of controlling a system using distributed controllers comprising:
networking a plurality of intelligent distributed controllers (IDCs) together such that said IDCs are communicably linked on a network, which network is communicably linked to a system;
storing a copy of a kernel command set in the electronic memory each IDC on said network;
storing a copy of a user application command set in said electronic memory of each said IDC on said network;
executing said kernel command set in each IDC on said network to enable each IDC to update at least a portion of its input/output (I/O) data with at least one other IDC on said network, where each said IDC electronically storing said updated I/O data in its said electronic memory;
executing said user application command set concurrently in each IDC on said network, said user application command set utilizing said updated I/O data stored in each IDC to determine appropriate outputs for controlling said system, such that said IDCs on said network forming a control system which controls said system; and
controlling said system with said outputs.

26. The method of claim 25 where said kernel command set includes an Operating System.

27. The method of claim 25 where a subset of all of the IDCs on said network forming a virtual network in which an IDC in said virtual network being operable to update its I/O values only in those IDCs also in said virtual network.

28. The method of claim 25 where each said IDC updates all of its input values with all other IDCs on said network.

29. The method of claim 25 where each said IDC also updates all of its output values with all other IDCs on said network.

30. The method of claim 25 where each IDC updates an input value with only those other IDCs which use that input to execute a command which affects an output controlled by said other IDCs.

31. The method of claim 25 where each IDC executes all commands of said user application command set, but ignores any instruction which would affect an output which it does not control.

32. The method of claim 25 further including the step of:
executing a second user application command set, stored in said electronic memory of the IDCs on said network, concurrently in each IDC on said network, said second user application command set utilizing said updated I/O data stored in each IDC to determine further appropriate outputs for controlling said system such that said IDCs on said network forming a control system which further controls said system, and controlling said system with said further appropriate outputs.

33. The method of claim 25 where said kernel command set being electronically stored in a first electronic memory of each said IDC, and said user application command set being electronically stored in a second electronic memory of each said IDC.

34. The method of claim 25 where any IDC on said network may be a Master Controller such that Master Controller status is floating.

35. The method of claim 34 where said kernel command set of at least the Master Controller IDC additionally directs said IDC to transmit a copy of at least one of said kernel command set and said user application command set to another IDC which is newly connected to a virtual network.

36. The method of claim 34 where said kernel command set of at least the Master Controller IDC additionally directs said IDC to transmit a copy of at least one of said kernel command set and said user application command set to another IDC when at least one of said kernel command set and said user application command set are updated in said electronic memory of said Master Controller IDC.

37. The method of claim 25 where said network of IDCs appearing to a programmer of said user application command set as a single virtual device

38. A method of updating software in distributed controllers comprising:
networking a plurality of intelligent distributed controllers (IDCs) together such that said IDCs are communicably linked on a network; and
enabling an IDC to update at least one of a kernel command set and a user application command set with at least a second IDC, where said at least a second IDC electronically storing said one of said kernel command set and said user application command set in an electronic memory of said at least a second IDC, and where said enabling is accomplished with a kernel command set electronically stored in said electronic memory of said IDC.

39. The method of claim 38 wherein said IDC which updates said second IDC being designated as a Master Controller.
